(19) United States
(12) Patent Application Publication
(10) Pub. No.: US 2014/0162136 A1
(43) Pub. Date: Jun. 12, 2014

(54) METHOD OF FORMING LITHIUM-ALUMINUM-TITANIUM PHOSPHATE

(71) Applicant: Electronics and Telecommunications Research Institute, Daejeon (KR)

(72) Inventors: Kunyoung KANG, Daejeon (KR); Young-Gi LEE, Daejeon (KR); Kwang Man KIM, Daejeon (KR); Dong Ok SHIN, Daejeon (KR)

(73) Assignee: Electronics and Telecommunications Research Institute, Daejeon (KR)

(21) Appl. No.: 13/950,441

(22) Filed: Jul. 25, 2013

(30) Foreign Application Priority Data
Dec. 12, 2012 (KR) 10-2012-0144269

(51) Int. Cl. H01M 10/0562; H01M 10/052; C01B 25/45

(52) U.S. Cl. CPC H01M 10/0562; C01B 25/45; H01M 10/052
USPC 429/319

(57) ABSTRACT

Disclosed are methods of forming lithium-aluminum-titanium phosphate. The method includes providing a precursor solution including a titanium compound and an aluminum compound, forming an intermediate using a hydrothermal reaction process performed on the precursor solution, adding a lithium compound and a phosphate compound to the intermediate, and firing a mixture of the lithium compound, the phosphate compound, and the intermediate.

### CROSS-REFERENCE TO RELATED APPLICATIONS

This U.S. non-provisional patent application claims priority under 35 U.S.C. §119 to Korean Patent Application No. 10-2012-0144269, filed on Dec. 12, 2012, the entirety of which is incorporated by reference herein.

### BACKGROUND

The inventive concept relates to lithium-aluminum-titanium phosphate and, more particularly, to a method of forming lithium-aluminum-titanium phosphate through hydrothermal reaction.

Lithium batteries are attractive in energy storage and conversion techniques. A lithium battery may include an anode, a separator, a cathode, and an electrolyte. The electrolyte functions as a medium through which ions are moved. The lithium batteries may be used as power supplies of portable electronic devices because of their high energy density, small size, and/or lightness. Recently, power consumptions of portable electronic devices increase with the performance improvement of the portable electronic devices, such that high powers of the lithium batteries are being demanded. Thus, the electrolyte having high ion conductance and low electric conductivity are required for generating a high power in the lithium battery.

The electrolyte of the lithium battery may include an organic liquid electrolyte and an inorganic solid electrolyte. Lithium salt dissolves in the organic liquid electrolyte. The organic liquid electrolyte is widely used because of its high ion conductance and stable electromechanical characteristics. However, the organic liquid electrolyte may cause various problems because of its high combustibility, volatility, and leakage. On the other hand, lithium-titanium phosphate may be used as the inorganic solid electrolyte. Ion conductance and electric conductivity of the lithium-titanium phosphate may be controlled by a structure and a doping state of the lithium-titanium phosphate. However, when the lithium-titanium phosphate is doped, impurities may be generated.

### SUMMARY

Embodiments of the inventive concept may provide a method of forming lithium-aluminum-titanium phosphate having a high degree of purity and high ion conductance.

In an aspect, a method of forming lithium-aluminum-titanium phosphate may include: providing a precursor solution including a titanium compound and an aluminum compound; forming an intermediate using a hydrothermal reaction process performed on the precursor solution; adding a lithium compound and a phosphate compound to the intermediate; and firing a mixture of the lithium compound, the phosphate compound, and the intermediate.

In an embodiment, forming the intermediate may include: performing the hydrothermal reaction process on the precursor solution to form a first intermediate; and thermally treating the first intermediate at a temperature of about 400 degrees Celsius to about 1000 degrees Celsius to form a second intermediate. In this case, the lithium compound and the phosphate compound may be added to the second intermediate.

In an embodiment, the first intermediate may be in an amorphous state; and the second intermediate may have a crystalline structure.

In an embodiment, the first intermediate may include titanium oxide and aluminum oxide.

In an embodiment, the precursor solution may further include a surfactant.

In an embodiment, the precursor solution may have a pH of about 3 to about 10.

In an embodiment, the hydrothermal reaction process may be performed at a temperature of about 120 degrees Celsius to about 240 degrees Celsius for a process time of about 2 hours to about 48 hours.

In an embodiment, firing the mixture may include: thermally treating the mixture at a temperature of about 700 degrees Celsius to about 1000 degrees Celsius for a time of about 3 hours to about 24 hours.

### BRIEF DESCRIPTION OF THE DRAWINGS

The inventive concept will become more apparent in view of the attached drawings and accompanying detailed description.

FIG. 1 is a flowchart illustrating a method of forming lithium-aluminum-titanium phosphate according to exemplary embodiments of the inventive concept;

FIG. 2 is a graph illustrating a result of X-ray diffraction analysis of a comparison example 1;

FIG. 3 is a graph illustrating a result of X-ray diffraction analysis of an experiment example 1; and

FIG. 4 is a graph illustrating an ion conductance of an experiment example 2 and an ion conductance of a comparison example 2.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

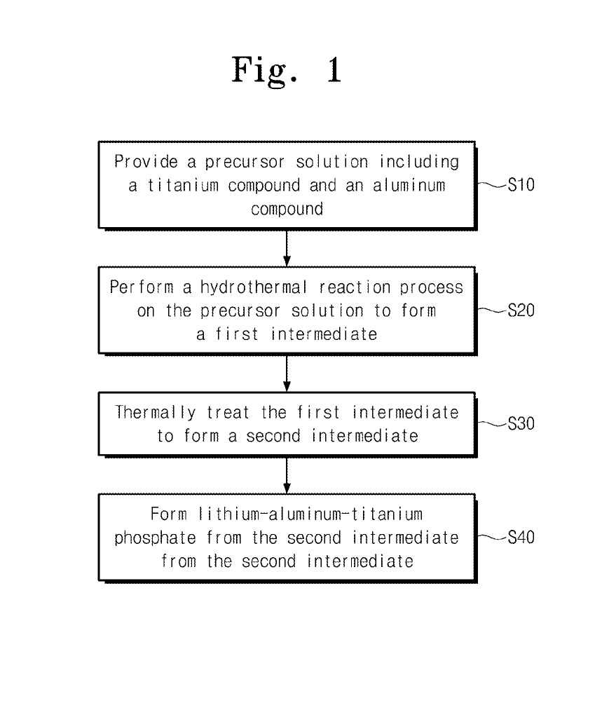

FIG. 1 is a flowchart illustrating a method of forming lithium-aluminum-titanium phosphate according to exemplary embodiments of the inventive concept.

Referring to FIG. 1, a titanium compound and an aluminum compound may be mixed with each other, thereby forming a precursor solution (S10). For example, the titanium compound may be added to a solvent, thereby forming a titanium solution. The titanium solution has a pH of about 1 to about 4, so that it has acidity. In an embodiment, the titanium solution may be formed by adding the titanium compound (e.g., titanyl sulphate (TiOSO₄), titanic sulfate (Ti(SO₄)₂), titanium chloride (TiCl), or titanium nitrate (Ti(NO₃)₄)) to a water solution or alcohol. In another embodiment, the titanium solution may be formed by a titanium organic compound (e.g., titanium isoproxide, titanium butoxide, or titanium methoxide) to an acidic solution.

The aluminum compound may be mixed with the titanium solution, so that a stoichiometric ratio of titanium to aluminum may have a range of about 95:5 to about 50:50 in the mixture of the aluminum compound and the titanium compound. The aluminum compound may include aluminum nitrate, aluminum sulphate, aluminum acetate, aluminum isoproxide, aluminum butoxide, or aluminum methoxide. The aluminum compound of a powder state may be mixed with titanium compound.

Alternatively, the aluminum compound may dissolve in water or alcohol to form an aluminum solution, and then the aluminum solution may be mixed with the titanium compound.

The precursor solution may be formed to have a pH of about 3 to about 10. In an embodiment, an alkaline solution (e.g., an ammonia water) may be added to the precursor solution including the titanium solution and the aluminum compound, so that the pH of the precursor solution may be controlled. In another embodiment, the alkaline solution may be added to the titanium solution, the aluminum compound, or each of the titanium solution and the aluminum compound, and then the aluminum compound may be mixed with the titanium solution to control the pH of the precursor solution. However, the inventive concept is not limited to the above mixing order of the alkaline solution, the aluminum compound, and the titanium solution. Since the precursor solution has the pH of about 3 to about 10, aluminum oxide may be easily generated from the added aluminum compound, and titanium oxide may be easily generated from the titanium compound of the precursor solution.

A surfactant may be added to the precursor solution in order that the titanium oxide and the aluminum oxide have substantially uniform particle sizes. The surfactant may include one of a polyethylene glycol-based material, polyethylene oxide, fatty acid, polyhydric alcohol, ester, an ether condensate, or any combination thereof.

A hydrothermal reaction process may be performed on the precursor solution to form a first intermediate (S20). The hydrothermal reaction means a synthesis reaction which is performed using water or a water solution at a high temperature and/or under a high pressure condition. The hydrothermal reaction process may be performed at a temperature of about 120 degrees Celsius to about 240 degrees Celsius. The hydrothermal reaction may not occur at a temperature lower than 120 degrees Celsius. If the hydrothermal reaction is performed at a temperature higher than 240 degrees Celsius, the first intermediate may be formed to have a non-uniform shape and/or a non-uniform size. The hydrothermal reaction process may be performed for a process time of about 2 hours to about 48 hours, more particularly, of about 8 hours to about 48 hours in order that the first intermediate has a suitable size and uniform particles. If the hydrothermal reaction process is performed for a process time less than two hours, a reaction time may be insufficient so that the first intermediate may have a very small particle size. If the hydrothermal reaction process is performed for a process time greater than 48 hours, the first intermediate may have a very large particle size. The condition of the hydrothermal reaction process may be controlled to control a particle size and/or a shape of the first intermediate. The particle size of the first intermediate may be controlled, so that reactivity of the first intermediate may be controlled. The first intermediate may have a higher reactivity with respect to a lithium compound and/or phosphate compound than the precursor solution. The first intermediate may include titanium oxide (e.g., TiO₂) and aluminum oxide (e.g., Al₂O₃). The first intermediate may be in an amorphous state.

A thermal treatment may be performed on the first intermediate to form a second intermediate (S30). The second intermediate may include titanium oxide and aluminum oxide and may be in a crystalline state. The second intermediate may be formed to be in a powder state. Thus, the second intermediate includes a plurality of particles. The first intermediate may be cleaned using distilled water or alcohol. The cleaned first intermediate may be dried at a temperature of about 80 degrees Celsius to 120 degrees Celsius. The first intermediate may be thermally treated at a temperature within a range of about 400 degrees Celsius to about 1000 degrees Celsius, more particularly, within a range of about 400 degrees Celsius to about 900 degrees Celsius. If the temperature of the thermal treatment is lower than 400 degrees Celsius, it is difficult to generate a crystal from the first intermediate. Thus, the second intermediate may not be formed. If the temperature of the thermal treatment is higher than 1000 degrees Celsius, the second intermediate may have a very large particle size (e.g., 3 μl or more). The particle size of the second intermediate may be controlled, so that reactivity of the second intermediate may be controlled. The second intermediate may have the particle size of about 500 nm to about 3 μm. A D50 of the second intermediate may have a range of about 1 μm to about 5 μm, and a D90 of the second intermediate may be about 7 μm or less. The D50 of the second intermediate means a particle diameter at 50% in the cumulative distribution of the particles of the second intermediate. That is, 50% of the particles of the second intermediate are larger than the D50, and 50% of the particles are smaller than the D50. The D90 of the second intermediate means a particle diameter at 90% in the cumulative distribution of the particles of the second intermediate. In other words, 10% of the particles of the second intermediate are larger than the D90, and 90% of the particles are smaller than the D90. The surfactant and/or a volatile ingredient included in the first intermediate may be removed by the thermal treatment. In another embodiment, the formation of the second intermediate by the thermal treatment may be omitted.

Lithium-aluminum-titanium phosphate may be formed from the second intermediate by a solid phase method (S40). A lithium compound and a phosphate compound may be stoichiometrically added to the second intermediate to form the lithium-aluminum-titanium phosphate (Li₁₊ₓAlₓTi₂₋ₓ(PO₄)₃), where ‘x’ is equal to or greater than 0 and equal to or less than 0.5. The lithium compound may include at least one of lithium carbonate (Li₂CO₃), lithium hydroxide (LiOH), lithium oxide (Li₂O), and lithium nitrate (LiNO₃). The phosphate compound may include diammonium phosphate ((NH₄)₂HPO₄). The phosphate compound may not include metal ions for reducing an impurity content of the lithium-aluminum-titanium phosphate. In an embodiment, the lithium compound, the phosphate compound, and the second intermediate may be mixed with each other by a ball milling method. In another embodiment, the lithium compound, the phosphate compound, and the second intermediate may be mixed with each other by using a solvent (e.g., alcohol) in which the lithium and phosphate compounds and the second intermediate do not dissolve. In still another embodiment, the lithium compound, the phosphate compound, and the second intermediate may be mixed with each other by a physical mixing method without the solvent. The mixture of the lithium compound, the phosphate compound, and the second intermediate may be fired at a temperature of about 700 degrees Celsius to about 1000 degrees Celsius for a firing time of about 3 hours to 24 hours, thereby forming the lithium-aluminum-titanium phosphate. The firing process may correspond to a thermal treatment. If the temperature of the firing process is lower than 700 degrees Celsius, the lithium-aluminum-titanium phosphate may have a low or bad crystallizability. If the temperature of the firing process is higher than 1000 degrees Celsius, the lithium-aluminum-titanium phosphate may have an excessive particle size, and an excessive energy may be consumed. If the firing time of the thermal treatment of the mixture is less than 3 hours, the lithium-aluminum-titanium phosphate may not be formed. If the firing time of the thermal treatment of the mixture is greater than 24, the formed lithium-aluminum-titanium phosphate may have an excessive particle size and/or a bad shape. As a result, the lithium-aluminum-titanium phosphate according to the inventive concept may be formed.

The lithium-aluminum-titanium phosphate formed according to the inventive concept is expressed as a chemical formula “Li₁₊ₓAlₓTi₂₋ₓ(PO₄)₃ (0≦x≦0.5)”.

Additionally, the lithium-aluminum-titanium phosphate may have a pure phase. The pure phase means that the lithium-aluminum-titanium phosphate (Li₁₊ₓAlₓTi₂₋ₓ(PO₄)₃) contain impurities less than 1%. A foreign substance may not be detected from the pure phase lithium-aluminum-titanium phosphate in X-ray diffraction analysis. In an embodiment, the impurities included in the lithium-aluminum-titanium phosphate may include aluminum phosphate (AlPO₄) or titanium pyrophosphate (TiP₂O₇). In another embodiment, the impurities included in the lithium-aluminum-titanium phosphate may include a magnetic metal (e.g., Fe, Cr, or Ni) or magnetic metal compound having a concentration of about 1 ppm or less. The lithium-aluminum-titanium phosphate may have a size of about 1 μl to about 5 μm.

Hereinafter, characteristic evaluation of the lithium-aluminum-titanium phosphate and the method of forming the same will be described in detail with reference to experiment examples performed according to the embodiments of the inventive concept.

### Formation of Lithium-Aluminum-Titanium Phosphate

### Experiment Example 1

### Formation of Intermediate of Aluminum Oxide and Titanium Oxide Through Hydrothermal Reaction

A surfactant P123 (a product of Aldrich Co. LLC.) is added to deionized water. A content of the surfactant P123 is 1 wt % of the deionized water. The surfactant P123 is mixed with the deionized water for 1 hour or more. Titanyl sulphate (TiOSO₄) is added to the deionized water, and then it is mixed with the deionized water for 2 hours or more. Aluminum nitrate nonahydrate (Al(NO₃)₃.9H₂O) is mixed with the deionized water to form a mixture solution. The hydrothermal reaction of the mixture solution is performed in an autoclave at a temperature of 170 degrees Celsius for 12 hours, thereby forming the first intermediate. The first intermediate is cleaned by deionized water and alcohol, and then the cleaned first intermediate is dried at a temperature of 80 degrees Celsius for 12 hours or more. The dried first intermediate is thermally treated at a temperature of 400 degrees Celsius, thereby forming the second intermediate. The second intermediate has globular particles of powder shape. The second intermediate may have particle sizes equal to or less than 7 μm.

### Formation of Lithium-Aluminum-Titanium Phosphate

Lithium carbonate and diammonium phosphate are added to the second intermediate, and then the mixture of the lithium carbonate, diammonium phosphate, and the second intermediate is milled for 1 hour. The mixture of the lithium carbonate, diammonium phosphate, and the second intermediate is heated from a room temperature to 900 degrees Celsius with a heating rate of 5 degrees increase per minute. And then the mixture of the lithium carbonate, diammonium phosphate, and the second intermediate is fired at the temperature of 900 degree Celsius for 6 hours, thereby forming lithium-aluminum-titanium phosphate. A chemical formula of the lithium-aluminum-titanium phosphate may be Li_{1.3}Al_{0.3}Ti_{1.7}(PO₄)₃. The lithium-aluminum-titanium phosphate may be milled to have a powder state.

### Comparison Example 1

Lithium-aluminum-titanium phosphate may be formed. However, in the present example, the formation of the intermediate through the hydrothermal reaction may be omitted. For example, lithium carbonate, aluminum nitrate nonahydrate, and diammonium phosphate may be stoichiometric ally mixed with each other by the solid phase method, the mixture is fired under the same condition as the experiment example 1, thereby forming the lithium-aluminum-titanium phosphate (Li_{1.3}Al_{0.3}Ti_{1.7}(PO₄)₃) of the comparison example 1.

### Formation and Characteristic Evaluation of Solid Electrolyte

### Experiment Example 2

### Formation of Solid Electrolyte

Pressure is applied to the lithium-aluminum-titanium phosphate to form a pellet having a thickness within a range of about 1 mm to about 1.5 mm. After the pellet is heated from a room temperature to 900 degrees Celsius with a heating rate of 5 degrees increase per minute, the pellet may be fired at a temperature of 900 degrees Celsius for 3 hours, thereby forming a solid electrolyte.

### Characteristic Evaluation of Solid Electrolyte

A copper foil, a carbon paste, the solid electrolyte, a carbon paste, and a copper foil are sequentially stacked and then may be dried to form a cell. The cell is dried at a temperature of 80 degrees Celsius for 12 hours in order to volatilize a solvent in the carbon pastes. An alternating current (AC) impedance of the solid electrolyte is measured using a frequency response analyzer (Solartron HF1225) under a frequency condition of about 10⁴ Hz to about 10⁵ Hz. An ion conductance of the solid electrolyte is calculated from the measured AC impedance.

### Comparison example 2

### Formation of Solid Electrolyte

The same processes as the experiment example 1 are performed on the lithium-aluminum-titanium phosphate of the comparison example 1, thereby forming a solid electrolyte of a comparison example 2.

### Characteristic Evaluation of Solid Electrolyte

An ion conductance of the solid electrolyte of the comparison example 2 is calculated by the same method as the experiment example 2. As described above, the solid electrolyte of the comparison example 2 is formed using the lithium-aluminum-titanium phosphate of the comparison example 1.

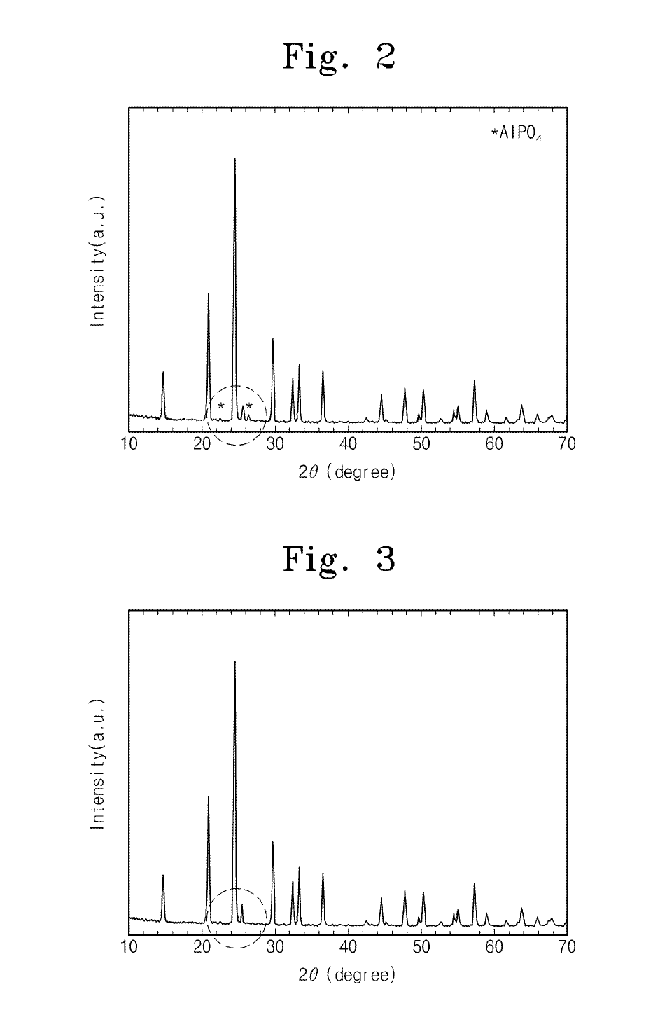

FIG. 2 is a graph illustrating a result of X-ray diffraction analysis of a comparison example 1. FIG. 3 is a graph illustrating a result of X-ray diffraction analysis of an experiment example 1.

Referring to FIG. 2, a peak * of aluminum phosphate (AlPO₄) is presented along with a peak of the lithium-aluminum-titanium phosphate in the lithium-aluminum-titanium phosphate of the comparison example 1. Thus, the lithium-aluminum-titanium phosphate of the comparison example 1 includes aluminum phosphate corresponding to the impurities.

Referring to FIG. 3, unlike the comparison example 1, a peak of aluminum phosphate is not presented in the lithium-aluminum-titanium phosphate of the experiment example 1. Thus, the lithium-aluminum-titanium phosphate of the experiment example 1 does not include the impurities. In the experiment example 1, the first intermediate is formed by the hydrothermal reaction and then the second intermediate having the crystalline structure is formed from the first intermediate. The lithium-aluminum-titanium phosphate of the experiment example 1 is formed using the second intermediate. The reactivity of the second intermediate with respect to the lithium compound and the phosphate compound is greater than that of the precursor solution. Thus, the lithium-aluminum-titanium phosphate of the experiment example 1, which is formed through the first and second intermediates, may have the pure phase not including the impurities.

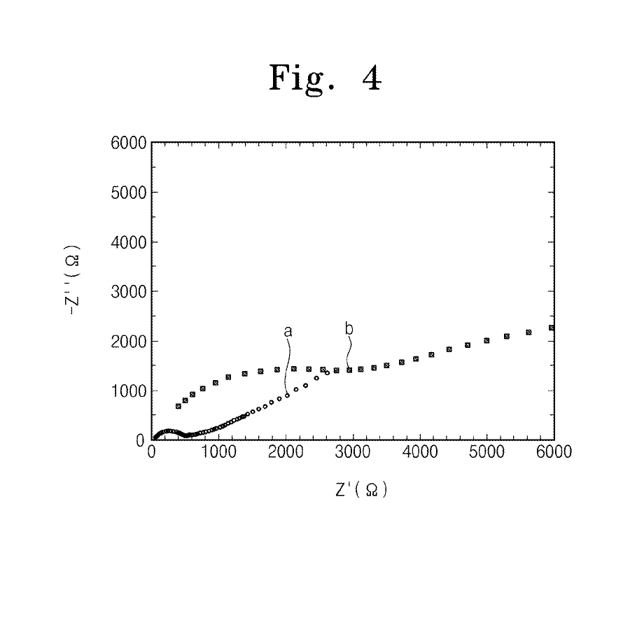

FIG. 4 is a graph illustrating an ion conductance of an experiment example 2 and an ion conductance of a comparison example 2.

Referring to FIG. 4, the solid electrolyte (a) of the experiment example 2 has the ion conductance of 1.3×10⁻⁴S/m, and the solid electrolyte (b) of the comparison example 2 has the ion conductance of 2.9×10⁻⁵S/m. Thus, the solid electrolyte (a) of the experiment example 2 has the ion conductance higher than that of the solid electrolyte (b) of the comparison example 2. Since the lithium-aluminum-titanium phosphate used in the experiment example 2 has a higher degree of purity than the lithium-aluminum-titanium phosphate used in the comparison example 2, the solid electrolyte (a) of the experiment example 2 may have the higher ion conductance than the solid electrolyte (b) of the comparison example 2.

According to embodiments of the inventive concept, the first intermediate may be formed by the hydrothermal reaction process, and then the second intermediate having the crystalline structure may be formed from the first intermediate. The lithium compound and the phosphate compound may be mixed with the second intermediate, and then the mixture of the lithium and phosphate compounds and the second intermediate may be fired to form the lithium-aluminum-titanium phosphate. The second intermediate may have the high reactivity with respect to the lithium compound and the phosphate compound. Thus, the lithium-aluminum-titanium phosphate formed through the first and second intermediates may have the pure phase not including the impurities. The formation processes of the first and second intermediates may be controlled to control the particle size and the shape of the lithium-aluminum-titanium phosphate. As a result, a lithium battery electrolyte including the lithium-aluminum-titanium phosphate described above may have the high ion conductance.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed is:

1. A method of forming lithium-aluminum-titanium phosphate, the method comprising:
providing a precursor solution including a titanium compound and an aluminum compound;
forming an intermediate using a hydrothermal reaction process performed on the precursor solution;
adding a lithium compound and a phosphate compound to the intermediate; and
firing a mixture of the lithium compound, the phosphate compound, and the intermediate.

2. The method of claim 1, wherein forming the intermediate comprises:
performing the hydrothermal reaction process on the precursor solution to form a first intermediate; and
thermally treating the first intermediate at a temperature of about 400 degrees Celsius to about 1000 degrees Celsius to form a second intermediate; and
wherein the lithium compound and the phosphate compound are added to the second intermediate.

3. The method of claim 2, wherein the first intermediate is in an amorphous state; and
wherein the second intermediate has a crystalline structure.

4. The method of claim 2, wherein the first intermediate includes titanium oxide and aluminum oxide.

5. The method of claim 1, wherein the precursor solution further includes a surfactant.

6. The method of claim 1, wherein the precursor solution has a pH of about 3 to about 10.

7. The method of claim 1, wherein the hydrothermal reaction process is performed at a temperature of about 120 degrees Celsius to about 240 degrees Celsius for a process time of about 2 hours to about 48 hours.

8. The method of claim 1, wherein firing the mixture comprises:
thermally treating the mixture at a temperature of about 700 degrees Celsius to about 1000 degrees Celsius for a time of about 3 hours to about 24 hours.
